(19) United States
(12) Patent Application Publication
(10) Pub. No.: US 2021/0226996 A1
(43) Pub. Date: Jul. 22, 2021

(54) Network Data Clustering

(71) Applicant: CYBER SEC BI LTD., Beer Sheva (IL)

(72) Inventors: Liv Aleen Remez, Kfar Shmaryahu (IL); Yaron Mashav, Ramat Gan (IL); Alex Vaystikh, Petah Tikva (IL)

(21) Appl. No.: 17/051,618

(22) PCT Filed: May 7, 2019
(86) PCT No.: PCT/IL2019/050515

§ 371 Date: Oct. 29, 2020

Related U.S. Application Data
(60) Provisional application No. 62/667,765, filed on May 7, 2018.

(51) Int. Cl. H04L 29/06; H04L 12/26; G06K 9/62

(52) U.S. Cl. CPC H04L 63/20; H04L 63/1425; G06K 9/6218; H04L 43/045; H04L 63/1416

(57) ABSTRACT

The present invention relates to a method for simulating security analysis of network data, comprising: receiving a dataset of network data records from which data relative to specific predefined fields are extracted; creating sessions by preprocessing the extracted data, wherein each session is defined by a single identification of a device; clustering the data in accordance with one or more of the created sessions; and evolving the dataset by updating the clustered data with new extracted data from the dataset.

### FIELD OF THE INVENTION

The present invention relates to the field of network security and analysis. More particularly, the invention relates to a method for simulating security analysis of network data by clustering said network data.

### BACKGROUND

Organizations usually have a proxy system (or computer) that generates records every time an organization device accesses a website. These generated records comprise data regarding the communication between the device and the website (e.g. who accessed whom, at what time, what was downloaded, etc.). The amount of records generated by an organization tends to be very large.

If a device is infected by malicious software then records regarding the infection may reside within this very large amount of records. Therefore many organizations hire a security analyst, whose task is to monitor the records with a strong search engine and manually detect any suspicious, anomalous or non-typical communication. Usually after finding such a communication, the security analyst searches for other records and devices that relate to the detected communication, from which a scenario is generated.

This is obviously a burdensome and imperfect process for a person to perform manually.

It is an object of the present invention to provide a method which is capable of clustering a large amount of data (especially network communication record data, syslogs) to groups/clusters of different types, thus the clustering automatically simulates the abovementioned manual process performed by a security analyst.

Other objects and advantages of the invention will become apparent as the description proceeds.

### SUMMARY OF THE INVENTION

The present invention relates to a method for simulating security analysis of network data, comprising:
a) receiving a dataset of network data records from which data relative to specific predefined fields are extracted;
b) creating sessions by preprocessing the extracted data, wherein each session is defined by a single identification of a device;
c) clustering the data in accordance with one or more of said created sessions; and
d) evolving the dataset by updating said clustered data with new extracted data from said dataset.

According to an embodiment of the invention, the method further comprises:
a) creating a filtering_list and filtering the dataset according thereto; and
b) creating a popular_referrers_list according to reoccurrences of referrers within the dataset.

According to an embodiment of the invention, the evolving comprises periodically updating and dynamically re-clustering the dataset, which may involve the following steps:
a) collecting new data records;
b) preprocessing said new data records to a new_data dataset by extracting relevant fields therefrom;
c) adding cs-host-domains that appear in the new_data dataset to a cs_host_domain_list;
d) appending and adding data records of existing clusters that contain a cs-host-domain appearing in the cs_host_domain_list to the new_data dataset, and creating therefrom a relevant_data dataset;
e) creating sessions based on the relevant_data dataset;
f) updating the filtering_list according to the relevant_data dataset and the created sessions;
g) updating the popular_referrers_list;
h) filtering the relevant_data dataset according to the updated filtering_list, and creating a new dataset data_for_clustering;
i) applying a clustering algorithm to the data_for_clustering dataset;
j) appending clusters from the clustering algorithm to existing clusters; and
k) repeating steps A to K.

According to an embodiment of the invention, the clustering algorithm runs the passes: GroupByDeviceSet; SplitSingleDeviceClusters; HostReferrerDevice; SingleUserAgent; DomainReferrer; SingleDomain; SingleRefdom; DigitDifferenceDomain; ReferrerSet; and MergeByDeviceSet.

In another aspect, the present invention relates to a system, comprising:
a) at least one processor; and
b) a memory comprising computer-readable instructions which when executed by the at least one processor causes the processor to execute a simulating security analysis of network data, wherein analysis:
   I. receives a dataset of network data records from which data relative to specific predefined fields are extracted;
   II. creates sessions by preprocessing the extracted data, wherein each session is defined by a single identification of a device;
   III. clusters the data in accordance with one or more of said created sessions; and
   IV. evolves the dataset by updating said clustered data with new extracted data from said dataset.

### BRIEF DESCRIPTION OF THE DRAWINGS

In the drawings:

FIG. 1 is a flowchart demonstrating the method of the present invention according to an embodiment; and

FIG. 2 is a flowchart demonstrating the process of evolution according to an embodiment of the invention.

### DETAILED DESCRIPTION OF THE INVENTION

According to an embodiment of the invention, the present invention relates to a method for simulating security analysis of network data. The method may involve the following steps:
receiving as input a dataset of network data records, for clustering;
preprocessing the dataset to sessions, wherein each session defines the activity of one device, and wherein each cluster may comprise of one or more sessions;
optionally, filtering the dataset for enhancing performance, by removing irrelevant data records for the clustering;
extracting numerous statistical indicators from the data to ensure that destination client-server-hosts (cs-hosts) don't aggregate and get clustered together with irrelevant cs-hosts, by e.g. calculating popular referrers list according to reoccurrences of referrers within the dataset; and
evolving the dataset.

The method of simulating security analysis of network data will be better understood through the following illustrative and non-limitative examples and embodiments.

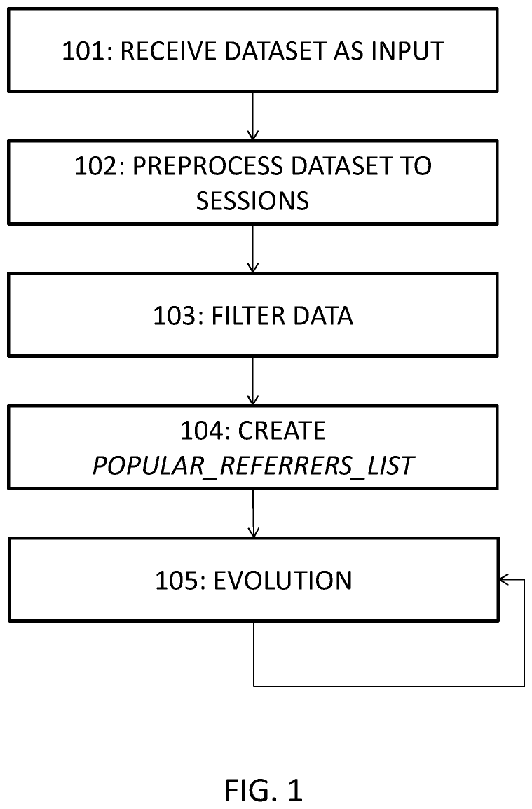

FIG. 1 is a flowchart demonstrating a method for simulating security analysis of network data, according to an embodiment of the present invention. At the first stage 101, an algorithm receives as input the dataset for clustering, i.e. records of network communication data. The records comprise raw data from which specific predefined fields are extracted per records. The fields may include, but are not limited to:
cs-host—the host header;
devicename—an identification that is given to a device assigned by the operating system or calculated from the data;
cs(referrer)—the referring host;
cs(user-agent)—the client string used for specific connection;
time—the time of the event;
frequency—frequency of communication, derived from individual time-stamps;
send/received bytes—the amount of data sent/received to/from server;

At the next stage 102, the dataset is preprocessed to sessions in order to create an additional field “devicename”. A session is defined as a continuous time period on the same c-IP that is attributed to some devicename. Due to the fact that c-IPs are sometimes randomly assigned and don't reflect real users, alongside the fact that usernames aren't always available in the data and availability of usernames can vary for different organizations, establishing devicenames is essential for correct clustering.

According to an embodiment of the invention, session classification may use machine learning. A simplified process may involve the following steps:
1. sort the data records (e.g. syslogs) by c-IP and timestamp;
2. if the time delta between two subsequent syslogs is less than a predefined time (e.g. 10 minutes), add them to the same session; otherwise start a new session;
3. for each sessions, define the most frequent username and apply it to all data records of the session as the records' devicenames;
   if there is not username available for the session, apply c-IP as devicename for all data records of the session;

In some cases of the above session recognizing process the username in the data may appear as a valid string (e.g. “UnknownUser”) denoting an undefined user or device. According to an embodiment of the invention, these usernames are automatically identified, and instead the username is used for creating sessions and, later on, for clustering.

In some embodiments of the invention, the data records may undergo a filtering process in stage 103 in order to enhance performance (e.g., by removing large amounts of irrelevant data records.

For example, given a referrer “google.com”, it is very common and will appear in many clusters as a cs-host or cs(referrer). If an exception isn't made for popular referrers then all clusters that contain “google.com” will merge into one relatively non-informative and non-specific cluster. In contrast, if a referrer is relatively rare and occurs only a few times in the data, it can efficiently be used to merge clusters that specifically and informatively co-relate.

According to an embodiment of the invention, the predefined amount of cs-host-domains pre referrer is constant. According to another embodiment of the invention, the amount can be defined statistically by applying learning the dataset and deciding, for instance that while 3 cs-host-domains sufficiently leads to good clusters 4 cs-host-domains lead to non-specific clustering. According to yet another embodiment of the invention, in order to prevent cases in which a referrer reaches the predefined amount but is still quite specific and therefore including it in clusters won't lead to non-specific clustering, a predicting algorithm is provided for preventing such cases for each referrer. According to still another embodiment of the invention a decay is applied to the predefined amount.

At the next stage 105, the data is periodically and dynamically clustered in a process called evolution, during which new clusters are created, records are added to existing clusters and existing clusters are merged, split or even deleted completely. It is noted that in contrary to traditional clustering schemes in which once clusters are created they are constant, evolution consists of continually testing and updating the clusters in order to reach the most ideal and specific clustering of the continually updated dataset.

Particularly, each time new data is added to the dataset (according to a predefined evolution frequency, e.g. once a day, once an hour, etc.), for each of the previously generated clusters that include cs-host-domains that appear in the new data, the data records are appended to the new data. Later clustering algorithms are run, and the new clusters are appended to the previously generated clusters.

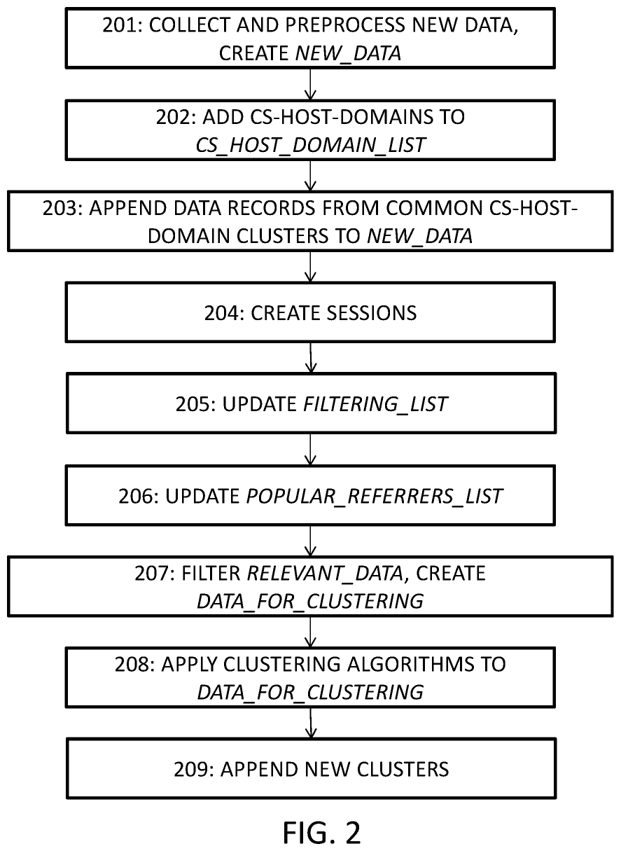

FIG. 2 is a flowchart demonstrating a process of evolution according to an embodiment of the invention. At the first stage 201, new data records are collected and preprocessed to new_data, i.e. the relevant fields (e.g. cs-host-domain, cs(referrer)-host, etc.) are extracted therefrom. At the next stage 202, cs-host-domains that appear in the new data records (i.e. in new_data) are added to a cs_host_domain_list. At the next stage 203, all of the existing clusters that contain a cs-host-domain which appears in the cs_host_domain_list are popped, and the data records thereof are appended to new_data and added to a dataset relevant_data. At the next stage 204, sessions are created based on the relevant_data dataset. At the next stage 205, the filtering_list is updated according to the relevant_data dataset and the sessions created at stages 203 and 204. At the next stage 206 domains are added and/or removed. At the next stage 207, the relevant_data dataset is created and a new dataset datajor_clustering is composed. At the next stage 208, clustering algorithms are applied to the datajor_clustering dataset, as explained below in detail. Finally at stage 209, new clusters are appended to existing clusters.

Due to the need to evaluate all existing clusters during each evolution, all the datasets used must be saved and stored for future reference and analysis. This would hypothetically require infinite memory resources on the long run. According to an embodiment of the invention, clusters with no updates are neglected and erased after a predefined timeout.

According to another embodiment of the invention, a decay algorithm is applied to the evolution process. For example, the algorithm may perform:
per cs-host, i.e. remove from existing clusters cs-hosts that did not reappear in sometime period (either a predefined fixed period or a function of specific cs-host frequency);
per cluster, i.e. if a cluster was not changed (e.g. addition of new data, split, merge) in some period of time, the cluster is archived and its data records are not included in future evolution cycles;

### Clustering Algorithm

A clustering algorithm according to an embodiment of the present invention receives data for clustering. The final output of the clustering algorithm is clusters of cs-hosts. The algorithm operates, for instance, as follows:
Clustering is performed at the resolution of cs-hosts and the algorithm creates clusters containing all relevant data records for those cs-hosts.
Generally, the approach of the algorithm is agglomerative (“from the bottom up” approach), i.e. each observation starts in its own cluster, and clusters are merged further as the algorithm proceeds.
The algorithm works in ensemble (multiple models), the first two of which create initial clusters based on unique sets of devicenames that access each cs-host. Each of the following passes analyzes a different aspect of the data, allowing the clusters to further merge based on a different feature in each pass. This approach tackles the multi-dimensionality challenge.
In each pass and for each feature, a merger_set is created at least for each relevant cluster. The merger_set is a set of all unique values that a cluster contains, for a given feature.
Deciding whether any two clusters should be merged or not is made according to overlaps of merger_sets of the two clusters. If there sufficient overlap, the clusters are merged.
Merging clusters is further performed in a manner resembling the density-based DBSCAN clustering. For example, if merger-set of cluster A overlaps with merger-set of cluster B ([merger_set (A) n merger_set (B)]>0), and merger-set of cluster B overlaps with merger-set of cluster C (merger set (B) n merger_set (C)>0), then all three should be merged. This process is repeated until the merger-sets of the remaining clusters have no overlaps with each other.
Finally, the MergeByDeviceSet pass merges the clusters to their final state based on devicename sets of clusters, i.e. all clusters with exactly the same set of devicenames are merged.

According to an embodiment of the invention, the clustering algorithm may comprise the following passes:
1. GroupByDeviceSet—this pass creates initial clusters. In this pass, the cs-hosts get clustered together based on the unique sets of devicenames that accessed them. The idea behind this step is that if, for example, two people accessed some cs-hosts that no one else accessed, these cs-hosts are similar to each other and different from other cs-hosts, and thus belong together.
2. SplitSingleDeviceClusters—This pass deals only with single-devicename clusters (i.e. clusters with more than one cs-host in which the set of devicenames for the cluster contains exactly one devicename), and splites these clusters into separate clusters for each cs-host, unless the cs-hosts are connected via common cs-host-domain or cs-referrer-domain. This is performed according to cs-host-domain or cs(referrer)-domain overlaps.
   For example, if two tuples (i.e. lists of data in data records) overlap in some of the fields (cs-host-domain or cs(referrer)-domain), they should be merged in one cluster. For instance, if cluster A contains tuple <d1, d2> where d1 is cs-host-domain and d2 is cs(referrer)-domain, and cluster B contains tuple <d2, d3>, these clusters should be merged because of the commonness of d2.
   After obtaining clusters and before proceeding to the next pass, for each cs(user-agent) the following indices are collected:
      alone_count—the amount of clusters in which the cs(user-agent) appeared alone; and
      together_count—the amount of cluster in which the cs(user-agent) appeard with other cs(user-agents).
   From these two above indices the probability of the cs(user-agent) to be found alone in a cluster (alone_score) is calculated according to Eq. 1. This score will be used in one of the following passes (SingleUserAgent pass).

$$alone\_score = \frac{alone\_count}{alone\_count + together\_count} \qquad Eq . 1$$

3. HostReferrerDevice—In this pass, if some devicename “X” referred to some cs-host “A” by some cs(referrer) “B”, there might be another data record where X accessed the cs-host “B”. This is based on the fact that every cs(referrer) was necessarily a cs-host in the past. In conclusion, cs-hosts “A” and “B” (and therefore their clusters containing) should be merged as basically they belong to the same chain of events.
   For example, three field are examined: cs-host, devicename and the cs(referrer) of each data record in each cluster. From the fields a matrix is created describing: <cshost; devicename> and <cs(referrer)-host; devicename> tuples. Merging is performed based on overlaps of tuples from any cluster. Any overlap justifies merging of clusters.
4. SingleUserAgent—This pass deals with only a single user-agent per cluster. Some user-agents are rare and more specific to the cs-hosts than other more common user-agents. These rare user-agents tend to appear as the only user-agent in the clusters that contain them. If there are two single-user-agent clusters with the same rare user-agent, they are merged. A benchmark is used for determining rareness of a user-agent, wherein if the score is above a predefined threshold, the user-agent is defined rare.
5. DomainReferrer—This pass is similar to the HostReferrerDevice pass (#3), although it doesn't cluster according to the devicenames. If a cs(referrer)-host refers to the same cs-host-domains in different clusters, then these clusters are merged.
6. SingleDomain—In this step, clusters in which all cs-hosts share a single domain (cs-host-domain) are merged with other clusters in which all cs-hosts share the same single domain. This is due to the assumption that if clusters with a single-domain exist at this point, then regardless of the source or cs(referrer) they should be merged.
   This pass works well on merging all clusters that contain variants of the same domain, different source sets, and mostly without referrers. For example web WhatsApp© version generates syslogs with cs-hosts such as {mmi491.whatsapp.net, mmi227.whatsapp.net, mms884.whatsapp.net, etc.}, with dozens of source for each cs-host variant. Therefore prior to this step there would be a lot of clusters with these variants for different sets of sources, whereas after this pass all those variants would be found in a single cluster.
7. SingleRefdom—This step is similar to SingleDomain, just that it examines the cs(referrer)-domain fields. Single-referrer clusters are merged together if the cs(referrer)-domain is the same. Clusters in which all of the cs(referrer)-domains are empty aren't merged in this step. If a cluster has two cs(referrers) and one of them is empty, this cluster should be considered a single cs(referrer) cluster.
8. DigitDifferenceDomains—Data may comprise cs-host-domain that are similar to each other, e.g using Levenshtein distance. For example, in the following tuples: {‘gexperiments1.com’; ‘gexperiments2.com’; ‘gexperiments3.com’}, {n121adserv.com’; ‘n131adserv.com’; ‘n139adserv.com’; ‘n142adserv.com’; ‘n197adserv.com’ etc.} The only difference between the cs-host-domains is merely a few digits. A list of such domains, digit_difference_domain_list, is kept and dynamically updated from cycle to cycle.
9. ReferrerSet—This pass is based on the observation that some clusters that share the same set of referrers usually have common devicenames and seem to relate to each other. In this pass merges cluster if there are overlaps of at least one devicename between the cluster and if they have exactly the same set of cs-referrer-hosts per cluster. There should be at least three distinct cs-referrer-hosts per cluster, not including dashes (‘-’) or other empty values.
   Although this pass merges a relatively small amount of clusters, these clusters have no other pass that merges them. According to an embodiment of the invention, clusters with high referrer similarity and high overlap of devicenames (above a predefined percentage threshold) merge.
10. MergeByDeviceSet—This pass merges clusters that have exactly the same set of devicenames. The logic behind this is that if exactly the same group of users after all passes appear in two or more different clusters, then these clusters should merge.

It should be noted that additional or other steps may be used as needed, with varying level of complexity.

After applying the clustering algorithm, comprising the above set of passes, on the datajor_clustering, the evolution process continues to another iteration cycle as explained above.

Although embodiments of the invention have been described by way of illustration, it will be understood that the invention may be carried out with many variations, modifications, and adaptations, without exceeding the scope of the claims.

1. A method for simulating security analysis of network data, comprising:
a) receiving a dataset of network data records from which data relative to specific predefined fields are extracted;
b) creating sessions by preprocessing the extracted data, wherein each session is defined by a single identification of a device;
c) clustering the data in accordance with one or more of said created sessions; and
d) evolving the dataset by updating said clustered data with new extracted data from said dataset.

2. The method according to claim 1, further comprising:
a) creating a filtering_list and filtering the dataset according thereto; and
b) creating a popular_referrers_list according to reoccurrences of referrers within the dataset.

3. A method according to claim 1, wherein the evolving comprises periodically updating and dynamically re-clustering the dataset.

4. A method according to claim 3, wherein the periodically updating and dynamically re-clustering the dataset, comprising:
a) collecting new data records;
b) preprocessing said new data records to a new_data dataset by extracting relevant fields therefrom;
c) adding cs-host-domains that appear in the new_data dataset to a cs_host_domain_list;
d) appending and adding data records of existing clusters that contain a cs-host-domain appearing in the cs_host_domain_list to the new_data dataset, and creating therefrom a relevant_data dataset;
e) creating sessions based on the relevant_data dataset;
f) updating the filtering_list according to the relevant_data dataset and the created sessions;
g) updating the popular_referrers_list;
h) filtering the relevant_data dataset according to the updated filtering_list, and creating a new dataset data_for_clustering;
i) applying a clustering algorithm to the data_for_clustering dataset;
j) appending clusters from the clustering algorithm to existing clusters; and
k) repeating steps A to K.

5. A method according to claim 4, wherein the clustering algorithm runs the passes: GroupByDeviceSet; SplitSingleDeviceClusters; HostReferrerDevice; SingleUserAgent; DomainReferrer; SingleDomain; SingleRefdom; DigitDifferenceDomain; ReferrerSet; and MergeByDeviceSet.

6. A system, comprising:
c) at least one processor; and
d) a memory comprising computer-readable instructions which when executed by the at least one processor causes the processor to execute a simulating security analysis of network data, wherein analysis:
I. receives a dataset of network data records from which data relative to specific predefined fields are extracted;
II. creates sessions by preprocessing the extracted data, wherein each session is defined by a single identification of a device;
III. clusters the data in accordance with one or more of said created sessions; and
IV. evolves the dataset by updating said clustered data with new extracted data from said dataset.
